(19) United States
(12) Patent Application Publication
(10) Pub. No.: US 2025/0333169 A1
(43) Pub. Date: Oct. 30, 2025

(54) ADAPTABLE TOILET FOR A LAVATORY OF A VEHICLE

(71) Applicant: THE BOEING COMPANY, Arlington, VA (US)

(72) Inventor: Darren Carl McIntosh, Mukilteo, WA (US)

(73) Assignee: THE BOEING COMPANY, Arlington, VA (US)

(21) Appl. No.: 19/016,031

(22) Filed: Jan. 10, 2025

Related U.S. Application Data
(60) Provisional application No. 63/639,008, filed on Apr. 26, 2024.

(51) Int. Cl. B64D 11/02

(52) U.S. Cl. CPC B64D 11/02

(57) ABSTRACT

An adaptable toilet (for use within a lavatory of an internal cabin of a vehicle) includes a urinal module configured to be fixed to one or both of a wall or a floor within the lavatory, and a toilet module pivotally coupled to the urinal module. The toilet module is configured to be upwardly pivoted into a stowed position. The toilet module is further configured to be downwardly pivoted from the stowed position into a deployed position in which the toilet module is supported over the urinal module.

### CROSS-REFERENCE TO RELATED APPLICATION

This application relates to and claims priority benefits from U.S. Provisional Patent Application No. 63/639,008, filed Apr. 26, 2024, which is hereby incorporated by reference in its entirety.

### FIELD OF THE DISCLOSURE

Examples of the present disclosure generally relate to an adaptable toilet for a lavatory of a vehicle, such as a commercial aircraft.

### BACKGROUND OF THE DISCLOSURE

Vehicles such as commercial aircraft are used to transport passengers between various locations. A typical commercial aircraft includes an internal cabin having one or more lavatories.

As can be appreciated, the space within a lavatory of a commercial aircraft is limited. A toilet within a lavatory of an aircraft typically includes a pivot toilet seat that allows for two independent modes of usage: seated use, in which the toilet seat is down, and standing use, in which the toilet seat is in an upright position. Despite the different modes, the toilet takes up the same amount of space within the lavatory in both modes.

### SUMMARY OF THE DISCLOSURE

A need exists for an adaptable toilet that allows for increased space within a lavatory of a vehicle, such as a commercial aircraft.

With that need in mind, certain examples of the present disclosure provide an adaptable toilet for use within a lavatory of an internal cabin of a vehicle. The adaptable toilet includes a urinal module configured to be fixed to one or both of a wall or a floor within the lavatory, and a toilet module pivotally coupled to the urinal module. The toilet module is configured to be upwardly pivoted into a stowed position. The toilet module is further configured to be downwardly pivoted from the stowed position into a deployed position in which the toilet module is supported over the urinal module.

In at least one example, the urinal module is configured to be fixed to both the wall and the floor.

In at least one example, the toilet module in the deployed position is supported over the urinal module.

In at least one example, the urinal module remains in a constant, fixed position when the toilet module is in the stowed position and the deployed position.

The toilet module pivotally couples to the urinal module at a pivot coupling.

The urinal module includes a base configured to be fixed to one or both of the floor or the wall. The base defines a receiving basin in fluid communication with a waste drain. The urinal module can also include an upper shroud upwardly extending from the base. The upper shroud defines a receiving channel in fluid communication with the receiving basin. The upper shroud can be configured to connect to a portion of the wall.

The toilet module includes a seat coupled to a bowl. The bowl defines an internal chamber. The internal chamber is in fluid communication with the receiving basin when the toilet module is in the deployed position.

The seat can rest against one or more portions of the upper shroud when the toilet module is in the stowed position.

Certain examples of the present disclosure provide a vehicle including an internal cabin, a lavatory within the internal cabin, and an adaptable toilet within the lavatory, as described herein.

Certain examples of the present disclosure provide a method including upwardly pivoting the toilet module from a deployed position in which the toilet module is supported over the urinal module into a stowed position; and downwardly pivoting the toilet module from the stowed position into the deployed position.

### BRIEF DESCRIPTION OF THE DRAWINGS

FIG. 1 illustrates a perspective front view of an aircraft, according to an example of the present disclosure.

FIG. 2 illustrates a perspective interior view of an internal cabin of an aircraft, according to an example of the present disclosure.

FIG. 3 illustrates an isometric internal view of a lavatory, according to an example of the present disclosure.

FIG. 4 illustrates a block diagram of a vehicle, according to an example of the present disclosure.

FIG. 5 illustrates a transverse cross-sectional view of an adaptable toilet having a toilet module in a deployed position, according to an example of the present disclosure.

FIG. 6 illustrates a transverse cross-sectional view of the adaptable toilet having the toilet module in a stowed position, according to an example of the present disclosure.

### DETAILED DESCRIPTION OF THE DISCLOSURE

The foregoing summary, as well as the following detailed description of certain embodiments will be better understood when read in conjunction with the appended drawings. As used herein, an element or step recited in the singular and preceded by the word “a” or “an” should be understood as not necessarily excluding the plural of the elements or steps. Further, references to “one embodiment” are not intended to be interpreted as excluding the existence of additional embodiments that also incorporate the recited features. Moreover, unless explicitly stated to the contrary, embodiments “comprising” or “having” an element or a plurality of elements having a particular condition can include additional elements not having that condition.

As described herein, certain examples of the present disclosure provide an adaptable toilet for use within a lavatory of an internal cabin of a vehicle. The adaptable toilet includes a urinal module configured to be fixed to one or both of a wall or a floor within the lavatory. A toilet module is pivotally coupled to the urinal module. The toilet module is configured to be upwardly pivoted into a stowed position. The toilet module is also configured to be downwardly pivoted from the stowed position into a deployed position in which the toilet module is supported over the urinal module. Further, certain examples of the present disclosure provide a vehicle including an internal cabin, a lavatory within the internal cabin, and an adaptable toilet within the lavatory.

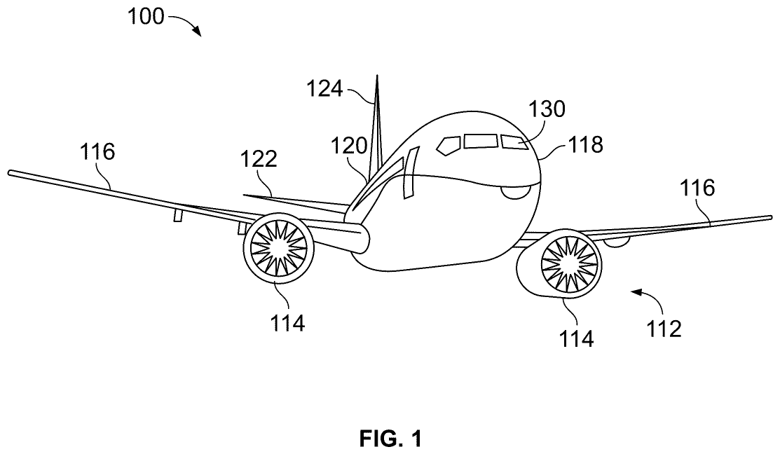

FIG. 1 illustrates a perspective front view of an aircraft 100, according to an example of the present disclosure. The aircraft 100 includes a propulsion system 112 that includes engines 114, for example. Optionally, the propulsion system 112 may include more engines 114 than shown. The engines 114 are carried by wings 116 of the aircraft 100. In other examples, the engines 114 may be carried by a fuselage 118 and/or an empennage 120. The empennage 120 may also support horizontal stabilizers 122 and a vertical stabilizer 124.

The fuselage 118 of the aircraft 100 defines an internal cabin 130, which includes a flight deck or cockpit, one or more work sections (for example, galleys, personnel carry-on baggage areas, and the like), one or more passenger sections (for example, first class, business class, and coach sections), one or more lavatories, and/or the like.

Alternatively, instead of an aircraft, examples of the present disclosure may be used with various other vehicles, such as automobiles, buses, locomotives and train cars, watercraft, spacecraft, and the like. As another example, examples of the present disclosure can be used in fixed structures, such as residential or commercial buildings.

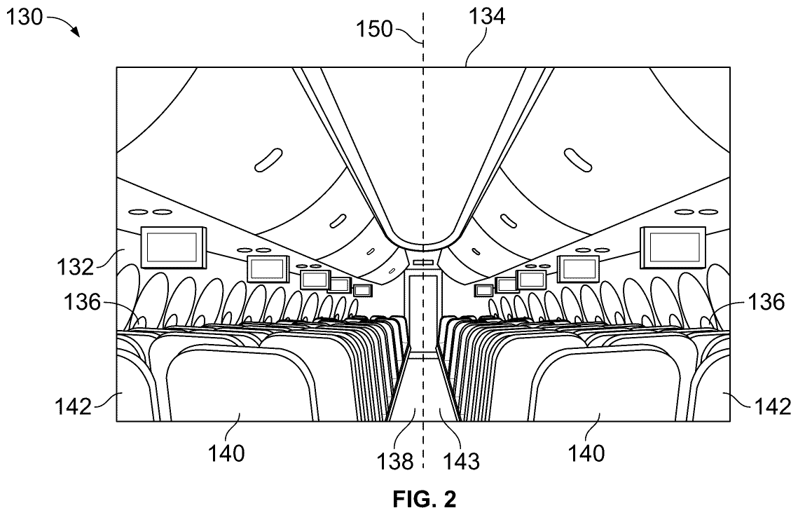

FIG. 2 illustrates a perspective interior view of an internal cabin 130 of an aircraft, according to an example of the present disclosure. The internal cabin 130 includes outboard walls 132 and a ceiling 134. Windows 136 may be formed within the outboard walls 132. A floor 138 supports rows of seats 140. As shown in FIG. 2, a row 142 may include three seats 140 on either side of an aisle 143. However, the row 142 may include more or less seats 140 than shown. Additionally, the internal cabin 130 may include more aisles than shown.

As used herein, the term “outboard” means a position that is further away from a central longitudinal plane 150 of the internal cabin 130 as compared to another component. The term “inboard” means a position that is closer to the central longitudinal plane 150 of the internal cabin 130 as compared to another component.

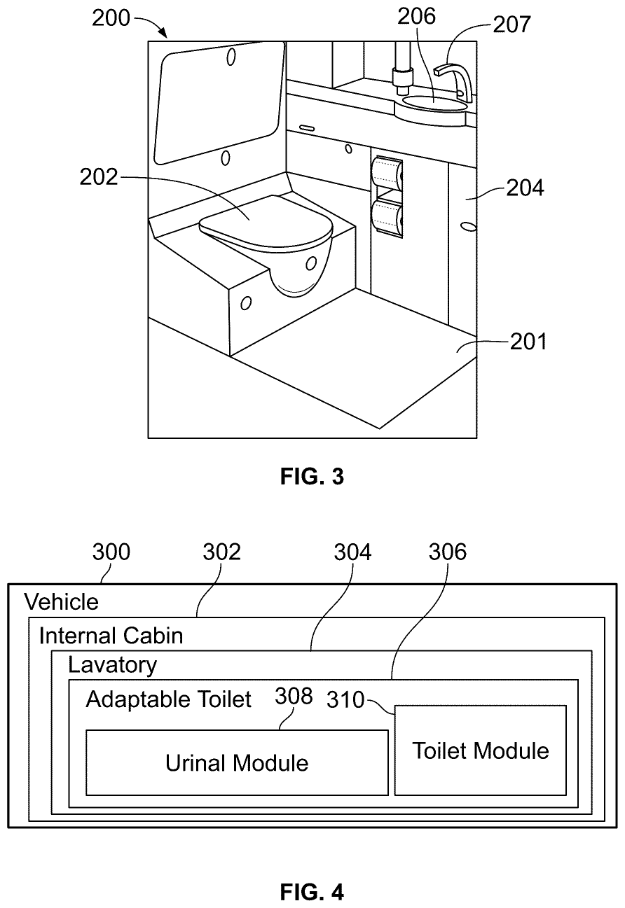

FIG. 3 illustrates an isometric internal view of a lavatory 200, according to an example of the present disclosure. In at least one example, the lavatory 200 can be disposed within an internal cabin 130 of an aircraft 100. Optionally, the lavatory 200 may be onboard various other vehicles. In other examples, the lavatory 200 may be within a fixed structure, such as a commercial or residential building. The lavatory 200 includes a base floor 201 that supports a toilet 202, one or more cabinets 204, a sink 206 or wash basin, and a faucet 207. In at least one example, the toilet 202 is an adaptable toilet, as described herein. The lavatory 200 may be arranged differently than shown. The lavatory 200 may include more or less components than shown.

FIG. 4 illustrates a block diagram of a vehicle 300, according to an example of the present disclosure. The aircraft 100 shown in FIG. 1 is an example of the vehicle 300. The vehicle 300 includes an internal cabin 302 (such as the internal cabin 130 shown in FIG. 2) having a lavatory 304 (such as the lavatory 200 shown in FIG. 3). The lavatory 304 includes an adaptable toilet 306, which includes a urinal module 308 pivotally coupled to a toilet module 310.

The toilet module 310 provides a fold-away portion. The adaptable toilet 306 is configured to optimize space within the lavatory 304. The toilet module 310 is configured to upwardly fold into a stowed position when not in use. The toilet module 310 includes a seat, and optionally a lid pivotally coupled to the seat. The toilet module 310 is pivotally coupled to the urinal module 308, which is smaller than the toilet module 310. In at least one example, the urinal module 308 is rigidly affixed to a wall within the lavatory 304, and has a smaller profile than the toilet module 310. For example, when the toilet module 310 is in the deployed position, the toilet module 310 extends forwardly past a base of the urinal module 308.

The adaptable toilet 306 allows for the toilet module 310 to be pivoted downwardly into a deployed position, in which the toilet module 310 is supported over the urinal module 308, thereby providing a larger toilet for seated use. The urinal module 308 remains in a constant, fixed position whether the toilet module 310 is in the stowed position, or the deployed position.

It has been found that the adaptable toilet 306 allows for additional space within the lavatory 304, such as an additional 12 inches of space. Additional space within a lavatory of a commercial aircraft, for example, has been, and continues to be highly desirable.

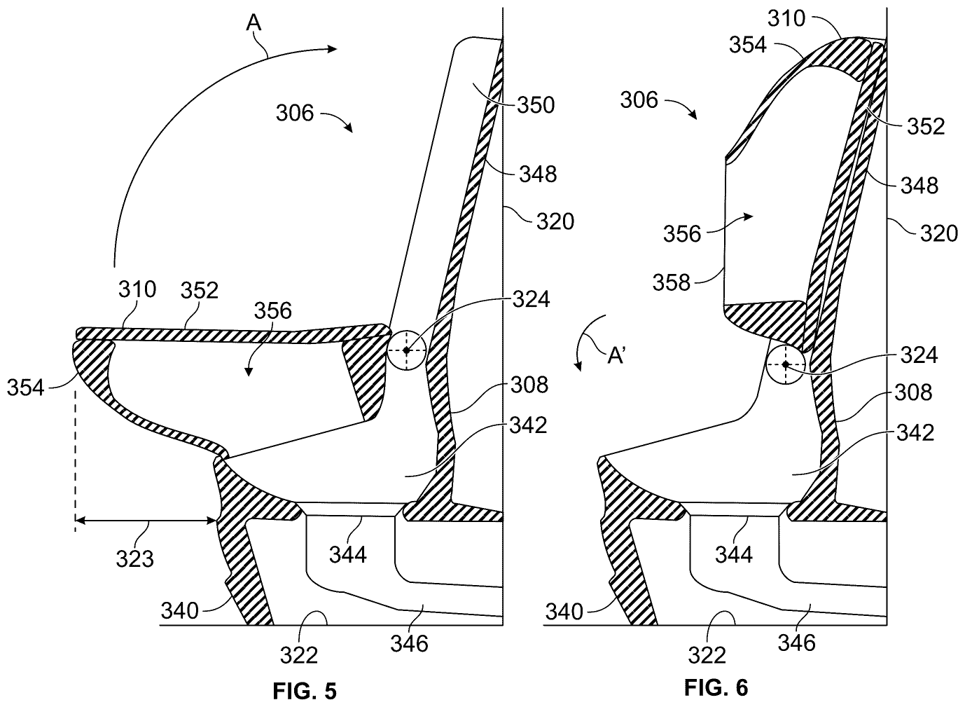

FIG. 5 illustrates a transverse cross-sectional view of the adaptable toilet 306 having the toilet module 310 in a deployed position, according to an example of the present disclosure. FIG. 6 illustrates a transverse cross-sectional view of the adaptable toilet 306 having the toilet module 310 in a stowed position, according to an example of the present disclosure.

Referring to FIGS. 5 and 6, in at least one example, the urinal module 308 is fixed to a wall 320 and a floor 322 of a lavatory 304. The toilet module 310 pivotally couples to the urinal module 308 at a pivot coupling 324, such as a radially hinged pivot connection. Referring to FIGS. 3-6, the toilet module 310 is configured to be folded up into the stowed position when not in use, thereby providing a substantial space savings within the lavatory 304. When the toilet module 310 is in the stowed position, the urinal module 308 allows use of the adaptable toilet 306 as a urinal.

Additional space 323 within the lavatory 304 is provided when the toilet module 310 is in the stowed position. For example, the additional space 323 can be approximately 12 extra inches of space within the lavatory 304. The additional space 323 can provide additional room for use of the adaptable toilet 306 within the lavatory 304 as a urinal, additional room for movement (handwashing, changing clothes, applying make-up, using baby changing table, etc.), and the like.

The urinal module 308 includes a base 340 fixed to the floor 322 and/or the wall 320. The base 340 defines a receiving basin 342 that is in fluid communication with a waste drain 344, which, in turn, is in fluid communication with a waste drainage conduit 346. In at least one example, the base 340 connects to an upper shroud 348 that extends upwardly from the base 340. The upper shroud 348 can connect to a portion of the wall 320. The upper shroud 348 defines receiving channel 350 that is in fluid communication with the receiving basin 342 of the base 340.

The toilet module 310 includes a lid 352 (defining an opening) coupled to a bowl 354 having an integral seat. The lid 352 can be pivotally coupled to the bowl 354, such that the lid 352 is able to pivot upwardly about a pivot connection with the bowl 354, and downwardly onto the bowl 354. Optionally, the lid 352 is fixed to the bowl 354. In at least one example, the toilet module 310 can also include a cover (not shown) that is pivotally coupled to the seat lid 352.

The bowl 354 defines an internal chamber 356. When the toilet module 310 is in the deployed position, the bowl 354 seats over the base 340 of the urinal module 308, such that the internal chamber 356 is in fluid communication with the receiving basin 342 of the urinal module 308. As such, contents deposited into the internal chamber 356 pass into the receiving basin 342, and subsequently into the waste drain 344, and the waste drainage conduit 346.

In order to provide the additional space 323, the toilet module 310 is pivoted upwardly from the deployed position (shown in FIG. 5) about the pivot coupling 324 in the direction of arc A into the stowed position (shown in FIG. 6). In the stowed position, the lid 352 can rest against the upper shroud 348 (for example, outer portions of the upper shroud 348 outside of the receiving channel 350) of the urinal module 308, and an opening 358 of the bowl 354 can face forward. In at least one example, a flap or cover can be disposed over the opening 358 when the toilet module 310 is in the stowed position. The toilet module 310 can then be pivoted downwardly from the stowed position about the pivot coupling in the direction of arc A′ into the deployed position.

In an example, the urinal module 308 can be configured as a waterless urinal, feeding into a vacuum flush system, via a small holding tank, without the need to flush. When the toilet module 310 is moved into the deployed position, contents are flushed using the conventional vacuum flush system, and also remove the content from the (urinal) holding tank. Both the urinal module 308 and the toilet module 310 feed into the same vacuum waste system.

In an example, the toilet module 310 can be configured to automatically move between the stowed position and the deployed position. For example, one or more actuators (such as an electric motor) can be operatively coupled to the pivot coupling 324 and/or the toilet module 310. The actuator(s) is in communication with a control panel (such as one or more buttons on the wall, for example), which are engageable to operate the actuator(s) to move the toilet module 310 between the stowed position and the deployed position. The actuators can be configured to operate electronically via touchless I.R. (infrared) button(s)/controller(s), or mechanically via a foot operated foot pedal. The toilet module 310 may also include a stored energy device, such as a spring to assist in operation. The toilet module 310 may also include a dampening device to prevent the toilet module 310 from slamming, when deployed.

Further, the disclosure comprises examples according to the following clauses:
Clause 1. An adaptable toilet for use within a lavatory of an internal cabin of a vehicle, the adaptable toilet comprising:
a urinal module configured to be fixed to one or both of a wall or a floor within the lavatory; and
a toilet module pivotally coupled to the urinal module,
wherein the toilet module is configured to be upwardly pivoted into a stowed position, and
wherein the toilet module is configured to be downwardly pivoted from the stowed position into a deployed position in which the toilet module is supported over the urinal module.
Clause 2. The adaptable toilet of Clause 1, wherein the urinal module is configured to be fixed to both the wall and the floor.
Clause 3. The adaptable toilet of Clauses 1 or 2, wherein the toilet module in the deployed position is supported over the urinal module.
Clause 4. The adaptable toilet of any of Clauses 1-3, wherein the urinal module remains in a constant, fixed position when the toilet module is in the stowed position and the deployed position.
Clause 5. The adaptable toilet of any of Clauses 1-4, wherein the toilet module pivotally couples to the urinal module at a pivot coupling.
Clause 6. The adaptable toilet of any of Clauses 1-5, wherein the urinal module comprises a base configured to be fixed to one or both of the floor or the wall, wherein the base defines a receiving basin in fluid communication with a waste drain.
Clause 7. The adaptable toilet of Clause 6, wherein the urinal module further comprises an upper shroud upwardly extending from the base, wherein the upper shroud defines a receiving channel in fluid communication with the receiving basin.
Clause 8. The adaptable toilet of Clause 7, wherein the upper shroud is configured to connect to a portion of the wall.
Clause 9. The adaptable toilet of Clauses 7 or 8, wherein the toilet module comprises a seat coupled to a bowl, wherein the bowl defines an internal chamber, wherein the internal chamber is in fluid communication with the receiving basin when the toilet module is in the deployed position.
Clause 10. The adaptable toilet of Clause 9, wherein the seat rests against one or more portions of the upper shroud when the toilet module is in the stowed position.
Clause 11. A vehicle comprising:
an internal cabin;
a lavatory within the internal cabin; and
an adaptable toilet within the lavatory, the adaptable toilet comprising:
   a urinal module fixed to one or both of a wall or a floor within the lavatory; and
   a toilet module pivotally coupled to the urinal module,
   wherein the toilet module is configured to be upwardly pivoted into a stowed position, and
   wherein the toilet module is configured to be downwardly pivoted from the stowed position into a deployed position in which the toilet module is supported over the urinal module.
Clause 12. The vehicle of Clause 11, wherein the urinal module is fixed to both the wall and the floor.
Clause 13. The vehicle of Clauses 11 or 12, wherein the toilet module in the deployed position is supported over the urinal module.
Clause 14. The vehicle of any of Clauses 11-13, wherein the urinal module remains in a constant, fixed position when the toilet module is in the stowed position and the deployed position.
Clause 15. The vehicle of any of Clauses 11-14, wherein the toilet module pivotally couples to the urinal module at a pivot coupling.
Clause 16. The vehicle of any of Clauses 11-15, wherein the urinal module comprises a base fixed to one or both of the floor or the wall, wherein the base defines a receiving basin in fluid communication with a waste drain.
Clause 17. The vehicle of Clause 16, wherein the urinal module further comprises an upper shroud upwardly extending from the base, wherein the upper shroud defines a receiving channel in fluid communication with the receiving basin, and wherein the upper shroud connects to a portion of the wall.
Clause 18. The vehicle of Clause 17, wherein the toilet module comprises a seat coupled to a bowl, wherein the bowl defines an internal chamber, wherein the internal chamber is in fluid communication with the receiving basin when the toilet module is in the deployed position.
Clause 19. The vehicle of Clause 18, wherein the seat rests against one or more portions of the upper shroud when the toilet module is in the stowed position.
Clause 20. A method for an adaptable toilet within a lavatory of an internal cabin of a vehicle, the adaptable toilet comprising:
a urinal module fixed to one or both of a wall or a floor within the lavatory; and
a toilet module pivotally coupled to the urinal module,
the method comprising:
upwardly pivoting the toilet module from a deployed position in which the toilet module is supported over the urinal module into a stowed position, and
downwardly pivoting the toilet module from the stowed position into the deployed position.

As described herein, examples of the present disclosure provide an adaptable toilet that allows for increased space within a lavatory of a vehicle, such as a commercial aircraft.

While various spatial and directional terms, such as top, bottom, lower, mid, lateral, horizontal, vertical, front and the like can be used to describe embodiments of the present disclosure, it is understood that such terms are merely used with respect to the orientations shown in the drawings. The orientations can be inverted, rotated, or otherwise changed, such that an upper portion is a lower portion, and vice versa, horizontal becomes vertical, and the like.

As used herein, a structure, limitation, or element that is “configured to” perform a task or operation is particularly structurally formed, constructed, or adapted in a manner corresponding to the task or operation. For purposes of clarity and the avoidance of doubt, an object that is merely capable of being modified to perform the task or operation is not “configured to” perform the task or operation as used herein.

It is to be understood that the above description is intended to be illustrative, and not restrictive. For example, the above-described embodiments (and/or aspects thereof) can be used in combination with each other. In addition, many modifications can be made to adapt a particular situation or material to the teachings of the various embodiments of the disclosure without departing from their scope. While the dimensions and types of materials described herein are intended to define the parameters of the various embodiments of the disclosure, the embodiments are by no means limiting and are exemplary embodiments. Many other embodiments will be apparent to those of skill in the art upon reviewing the above description. The scope of the various embodiments of the disclosure should, therefore, be determined with reference to the appended claims, along with the full scope of equivalents to which such claims are entitled. In the appended claims and the detailed description herein, the terms “including” and “in which” are used as the plain-English equivalents of the respective terms “comprising” and “wherein.” Moreover, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

This written description uses examples to disclose the various embodiments of the disclosure, including the best mode, and also to enable any person skilled in the art to practice the various embodiments of the disclosure, including making and using any devices or systems and performing any incorporated methods. The patentable scope of the various embodiments of the disclosure is defined by the claims, and can include other examples that occur to those skilled in the art. Such other examples are intended to be within the scope of the claims if the examples have structural elements that do not differ from the literal language of the claims, or if the examples include equivalent structural elements with insubstantial differences from the literal language of the claims.

What is claimed is:

1. An adaptable toilet for use within a lavatory of an internal cabin of a vehicle, the adaptable toilet comprising:
a urinal module configured to be fixed to one or both of a wall or a floor within the lavatory; and
a toilet module pivotally coupled to the urinal module,
wherein the toilet module is configured to be upwardly pivoted into a stowed position, and
wherein the toilet module is configured to be downwardly pivoted from the stowed position into a deployed position in which the toilet module is supported over the urinal module.

2. The adaptable toilet of claim 1, wherein the urinal module is configured to be fixed to both the wall and the floor.

3. The adaptable toilet of claim 1, wherein the toilet module in the deployed position is supported over the urinal module.

4. The adaptable toilet of claim 1, wherein the urinal module remains in a constant, fixed position when the toilet module is in the stowed position and the deployed position.

5. The adaptable toilet of claim 1, wherein the toilet module pivotally couples to the urinal module at a pivot coupling.

6. The adaptable toilet of claim 1, wherein the urinal module comprises a base configured to be fixed to one or both of the floor or the wall, wherein the base defines a receiving basin in fluid communication with a waste drain.

7. The adaptable toilet of claim 6, wherein the urinal module further comprises an upper shroud upwardly extending from the base, wherein the upper shroud defines a receiving channel in fluid communication with the receiving basin.

8. The adaptable toilet of claim 7, wherein the upper shroud is configured to connect to a portion of the wall.

9. The adaptable toilet of claim 7, wherein the toilet module comprises a seat coupled to a bowl, wherein the bowl defines an internal chamber, wherein the internal chamber is in fluid communication with the receiving basin when the toilet module is in the deployed position.

10. The adaptable toilet of claim 9, wherein the seat rests against one or more portions of the upper shroud when the toilet module is in the stowed position.

11. A vehicle comprising:
an internal cabin;
a lavatory within the internal cabin; and
an adaptable toilet within the lavatory, the adaptable toilet comprising:
a urinal module fixed to one or both of a wall or a floor within the lavatory; and
a toilet module pivotally coupled to the urinal module,
wherein the toilet module is configured to be upwardly pivoted into a stowed position, and
wherein the toilet module is configured to be downwardly pivoted from the stowed position into a deployed position in which the toilet module is supported over the urinal module.

12. The vehicle of claim 11, wherein the urinal module is fixed to both the wall and the floor.

13. The vehicle of claim 11, wherein the toilet module in the deployed position is supported over the urinal module.

14. The vehicle of claim 11, wherein the urinal module remains in a constant, fixed position when the toilet module is in the stowed position and the deployed position.

15. The vehicle of claim 11, wherein the toilet module pivotally couples to the urinal module at a pivot coupling.

16. The vehicle of claim 11, wherein the urinal module comprises a base fixed to one or both of the floor or the wall, wherein the base defines a receiving basin in fluid communication with a waste drain.

17. The vehicle of claim 16, wherein the urinal module further comprises an upper shroud upwardly extending from the base, wherein the upper shroud defines a receiving channel in fluid communication with the receiving basin, and wherein the upper shroud connects to a portion of the wall.

18. The vehicle of claim 17, wherein the toilet module comprises a seat coupled to a bowl, wherein the bowl defines an internal chamber, wherein the internal chamber is in fluid communication with the receiving basin when the toilet module is in the deployed position.

19. The vehicle of claim 18, wherein the seat rests against one or more portions of the upper shroud when the toilet module is in the stowed position.

20. A method for an adaptable toilet within a lavatory of an internal cabin of a vehicle, the adaptable toilet comprising:
a urinal module fixed to one or both of a wall or a floor within the lavatory; and
a toilet module pivotally coupled to the urinal module,
the method comprising:
upwardly pivoting the toilet module from a deployed position in which the toilet module is supported over the urinal module into a stowed position; and
downwardly pivoting the toilet module from the stowed position into the deployed position.
